(19) United States
(12) Patent Application Publication
(10) Pub. No.: US 2022/0361150 A1
(43) Pub. Date: Nov. 10, 2022

(54) METHOD FOR DETERMINING UPLINK RESOURCE AND COMMUNICATIONS DEVICE

(71) Applicant: VIVO MOBILE COMMUNICATION CO., LTD., Dongguan (CN)

(72) Inventors: Siqi LIU, Dongguan (CN); Zichao JI, Dongguan (CN); Shixiao LIU, Dongguan (CN)

(73) Assignee: VIVO MOBILE COMMUNICATION CO., LTD., Dongguan (CN)

(21) Appl. No.: 17/868,720

(22) Filed: Jul. 19, 2022

Related U.S. Application Data
(63) Continuation of application No. PCT/CN2021/072524, filed on Jan. 18, 2021.

(30) Foreign Application Priority Data
Jan. 20, 2020 (CN) 202010066292.4

(51) Int. Cl. H04W 72/02; H04W 72/04; H04L 5/00

(52) U.S. Cl. CPC H04W 72/02; H04W 72/0453; H04W 72/0446; H04L 5/0012

(57) ABSTRACT

A method for determining an uplink resource and a communications device are provided. The method includes determining a target uplink channel based on at least one target resource. The target resource includes a resource pool, a subchannel, a Bandwidth Part (BWP), or a carrier.

### CROSS-REFERENCE TO RELATED APPLICATIONS

This application is a continuation of International Application No. PCT/CN2021/072524, filed on Jan. 18, 2021, which claims priority to Chinese Patent Application No. 202010066292.4 filed on Jan. 20, 2020. The entire contents of each of the above-referenced applications are expressly incorporated herein by reference.

### TECHNICAL FIELD

The present disclosure relates to the communications field, and in particular to a method for determining an uplink resource and a communications device.

### BACKGROUND

At present, a New Radio (NR) mobile communication system (NR system for short) supports transmission on a Sidelink (SL, also called a side link, a direct link, a direct communication link, or the like). To improve reliability and resource utilization of data transmission on the SL, a Hybrid Automatic Repeat Request (HARQ) feedback mechanism is introduced into the SL technology.

For example, a process of the SL HARQ feedback mechanism may include: after a SL receiving user receives SL data, SL HARQ feedback information is fed back to indicate whether the transmission on the SL succeeds or fails. After a SL sending user receives the SL HARQ feedback information on the SL, it can be known whether the previous transmission on the SL succeeds. A SL user may be a sending user or a receiving user, that is, a same user can perform receiving or sending respectively in different time or frequency domains. The SL HARQ feedback information includes Acknowledgement (ACK) information and Negative Acknowledgement (NACK) information.

In addition, transmission of a SL data packet may be performed on a SL between users. Therefore, a control node may not directly know whether the transmission of the SL data packet succeeds, and the user needs to send the SL HARQ feedback information to the control node, so that the control node can further determine whether the transmission on the SL succeeds. Therefore, a scheme for determining an uplink resource is required, so that the user can report corresponding information smoothly, so as to be consistent with information understood by the control node.

### SUMMARY

According to a first aspect, an embodiment of the present disclosure provides a method for determining an uplink resource, applied to a communications device and including:

determining a target uplink channel based on at least one target resource, where the target resource includes a resource pool, a subchannel, a Bandwidth Part (BWP), or a carrier.

According to a second aspect, an embodiment of the present disclosure provides a communications device, including:

a determining module, configured to determine a target uplink channel based on at least one target resource, where the target resource includes a resource pool, a subchannel, a BWP, or a carrier.

According to a third aspect, an embodiment of the present disclosure provides a communications device, including: a memory, a processor, and a computer program that is stored in the memory and that can be run on the processor, where when the computer program is executed by the processor, the steps of the method according to the first aspect are implemented.

According to a fourth aspect, an embodiment of the present disclosure provides a computer-readable storage medium, where the computer-readable storage medium stores a computer program, and when the computer program is executed by a processor, the steps of the method according to the first aspect are implemented.

In an embodiment of the present disclosure, the target uplink channel can be accurately determined based on at least one target resource. That is, a required uplink resource can be accurately determined. Consequently, a user can report corresponding information smoothly, so as to be consistent with information understood by a control node. The target resource may include a resource pool, a subchannel, a BWP, or a carrier.

### BRIEF DESCRIPTION OF DRAWINGS

The accompanying drawings described herein are used to provide further understanding of the present disclosure and constitute a part of the present disclosure. The illustrative embodiments of the present disclosure and descriptions thereof are used to explain the present disclosure, and do not constitute any improper limitation on the present disclosure. In the accompanying drawings:

FIG. 1 is a schematic flowchart of a method for determining an uplink resource according to an embodiment of the present disclosure;

FIG. 2 is a schematic structural diagram of a communications device according to an embodiment of the present disclosure;

FIG. 3 is a schematic structural diagram of a terminal device according to an embodiment of the present disclosure; and

FIG. 4 is a schematic structural diagram of a network device according to an embodiment of the present disclosure.

### DETAILED DESCRIPTION

The following clearly describes the technical solutions in the embodiments of the present disclosure with reference to the accompanying drawings in the embodiments of the present disclosure. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

The technical solutions of the present disclosure may be applied to various communications systems, such as a Global System of Mobile communication (GSM), a Code Division Multiple Access (CDMA) system, Wideband Code Division Multiple Access (WCDMA), a General Packet Radio Service (GPRS), Long Term Evolution (LTE)/Long Term Evolution Advanced (LTE-A), and NR.

User equipment UE, also referred to as a terminal device, mobile user equipment, or the like, may communicate with one or more core networks through a Radio Access Network (RAN). The user equipment may be a terminal device, such as a mobile phone (or referred to as a “cellular” phone) and a computer with the terminal device. For example, the user equipment may be a portable, pocket-sized, handheld, computer built-in, or in-vehicle mobile apparatus, which exchanges a language and/or data with the radio access network.

A network device, also called a base station, may be a Base Transceiver Station (BTS) in GSM or CDMA, or may be a NodeB in WCDMA, or may be an evolved NodeB (evolutional Node B, Node eNB, or e-NodeB) in LTE and a 5G base station (gNB).

The following describes in detail the technical solutions provided in the embodiments of the present disclosure with reference to the accompanying drawings.

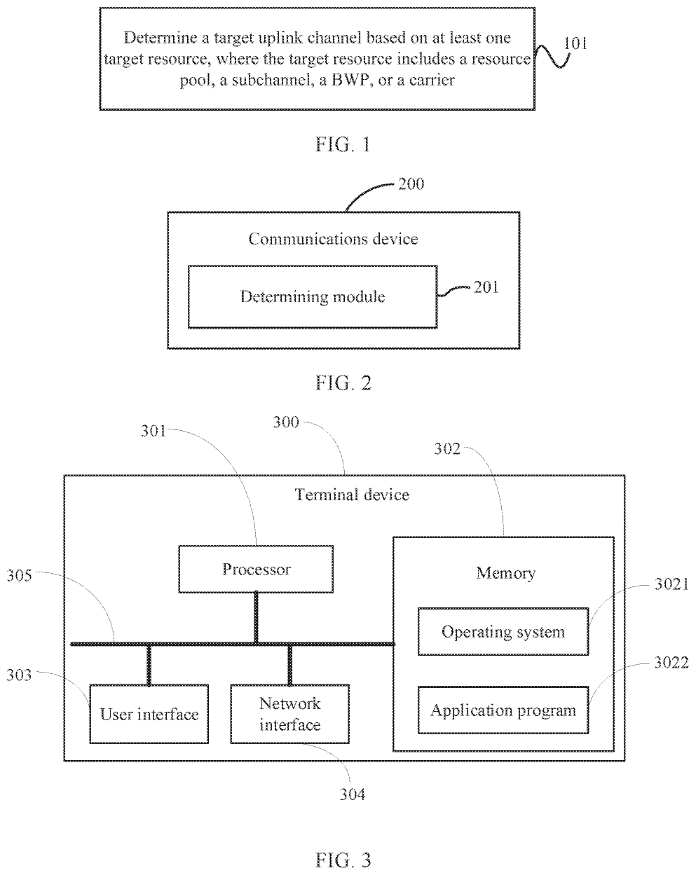

Referring to FIG. 1, an embodiment of the present disclosure provides a method for determining an uplink resource. The method is performed by a communications device. The communications device may be a network device or a terminal device. The method includes the following procedure.

Step 101: Determine a target uplink channel based on at least one target resource, where the target resource includes a resource pool, a subchannel, a BWP, or a carrier.

In this embodiment of the present disclosure, the target uplink channel can be accurately determined based on at least one target resource. That is, a required uplink resource can be accurately determined. Consequently, a user can report corresponding information smoothly, so as to be consistent with information understood by a control node. The target resource may include a resource pool, a subchannel, a BWP, or a carrier.

In some embodiments, the method for determining an uplink resource according to this embodiment of the present disclosure may further include the following: performing uplink transmission through the foregoing target uplink channel. This way, the user can report the corresponding information smoothly, so as to be consistent with the information understood by the control node.

In some embodiments, the target uplink channel may include a Physical Uplink Control Channel (PUCCH) or a Physical Uplink Shared Channel (PUSCH). The target uplink channel may be allocated by the network device.

In some embodiments, an association relationship between the target uplink channel and the at least one target resource includes at least one of the following:

(1) The target uplink channel is associated with one or more target resources of the at least one target resource.

In some embodiments, the target uplink channel is associated with an Identifier (ID) of one or more target resources of the at least one target resource. An ID of each target resource may be indicated by control signaling or higher layer signaling. The higher layer signaling may include at least one of Radio Resource Control (RRC) signaling, Packet Data Convergence Protocol (PDCP) signaling, Service Data Adaptation Protocol (SDAP) signaling, Radio Link Control (RLC) signaling, Medium Access Control (MAC) signaling, or the like.

(2) A resource set of the target uplink channel is associated with an ID of one or more target resources of the at least one target resource.

In some embodiments, the resource set of the target uplink channel is associated with the ID of the one or more target resources of the at least one target resource.

(3) A format of the target uplink channel is associated with one or more target resources of the at least one target resource.

In some embodiments, the format of the target uplink channel is associated with an ID of the one or more target resources of the at least one target resource.

(4) A sequence of the target uplink channel is associated with one or more target resources of the at least one target resource.

In some embodiments, the sequence of the target uplink channel is associated with an ID of the one or more target resources of the at least one target resource. The sequence of the target uplink channel includes at least one of a base sequence, initialization, cyclic shift, phase rotation, or the like.

(5) A frequency domain resource of the target uplink channel is associated with one or more target resources of the at least one target resource.

In some embodiments, the frequency domain resource of the target uplink channel is associated with an ID of the one or more target resources of the at least one target resource.

(6) A time domain resource of the target uplink channel is associated with one or more target resources of the at least one target resource.

In some embodiments, the time domain resource of the target uplink channel is associated with an ID of the one or more target resources of the at least one target resource.

(7) A frequency hopping pattern of the target uplink channel is associated with one or more target resources of the at least one target resource.

In some embodiments, the frequency hopping pattern of the target uplink channel is associated with an ID of the one or more target resources of the at least one target resource. The frequency hopping pattern is used for frequency hopping by the communications device.

In some embodiments, in the method for determining an uplink resource according to this embodiment of the present disclosure, the foregoing target uplink channel is associated with a target sidelink channel resource. The target sidelink channel resource includes at least one of a Physical Sidelink Feedback Channel (PSFCH) resource, a Physical Sidelink Shared Channel (PSSCH) resource, or a Physical Sidelink Control Channel (PSCCH) resource.

In some embodiments, the method for determining an uplink resource according to this embodiment of the present disclosure may further include the following:

determining SL HARQ feedback information based on the target sidelink channel resource associated with the foregoing target uplink channel.

In this embodiment of the present disclosure, after the target uplink channel is determined based on the at least one target resource, the SL HARQ feedback information to be reported by the user on a sidelink may be further determined based on the target sidelink channel resource associated with the target uplink channel. This way, the user on the sidelink can accurately determine content of the SL feedback information to be reported, so that the user on the sidelink can report the SL feedback information smoothly, so as to be consistent with information understood by the control node.

In some embodiments, in the method for determining an uplink resource according to this embodiment of the present disclosure, performing uplink transmission through the target uplink channel can be implemented as follows:

uplink transmission is performed for the SL HARQ feedback information through the target uplink channel. This way, the SL HARQ feedback information determined based on the target sidelink channel resource associated with the target uplink channel can be mapped to the target uplink channel, so that reporting can be completed.

In some embodiments, the SL HARQ feedback information includes ACK information or NACK information, and a value of a feedback bit corresponding to the ACK information set to “1”, and a value of a feedback bit corresponding to the NACK information set to “0”, or a value of a feedback bit corresponding to the ACK information set to “0”, and a value of a feedback bit corresponding to the NACK information set to “1”. Further, the SL HARQ feedback information is transmitted in a form of an SL codebook on the foregoing target uplink channel, so that SL HARQ feedback information corresponding to multiple pieces of data is fed back on a same resource, such as SL HARQ feedback information corresponding to multiple TBs, thereby achieving the purpose of reducing feedback complexity. An exemplary implementation manner is that the SL codebook can be represented as a bitmap or a matrix. In addition, a manner in which the SL codebook is constructed based on the SL HARQ feedback information determined according to this embodiment of the present disclosure can achieve the purpose of reducing burdens of the user in terms of reporting, coding complexity, and the like, reducing codebook overhead, and improving reliability of feedback of the SL HARQ feedback information based on uplink transmission.

In some embodiments, the target uplink channel can feed back SL HARQ feedback information corresponding to a PSFCH resource or PSSCH resource in a specified target resource only; or can feed back SL HARQ feedback information corresponding to a PSFCH resource or PSSCH resource in some specified target resources; or can further feed back SL HARQ feedback information corresponding to a PSFCH resource or PSSCH resource in any target resource.

In some embodiments, in a method for determining SL feedback information according to this embodiment of the present disclosure, the following may be further included:

whether the SL HARQ feedback information can be transmitted on a PUSCH is indicated by a 1-bit Downlink Assignment Indicator (DAI) in DCI.

In some embodiments, in an example, the target sidelink channel resource includes at least one resource beyond a sidelink channel resource range corresponding to the at least one target resource.

In some embodiments, in this example, all SL HARQ feedback information corresponding to the at least one resource beyond the sidelink channel resource range corresponding to the at least one target resource is one of the ACK information and negative NACK information.

For example, in an example, one PUCCH is associated with resource pool #1, and the PUCCH is associated with 4 PSFCH occasions, occasion#1, occasion#2, occasion#3, and occasion#4. Occasion#3 in the 4 PSFCH occasions belongs to resource pool#2, and the other three occasions belong to resource pool#1. Therefore, when the PUCCH feeds back HARQ-ACK bits of the 4 PSFCH occasions, HARQ-ACK bits corresponding to occasion#3 are all set to ACK information.

In another example, one PUCCH is associated with resource pool #1, and the PUCCH is associated with 4 PSFCH occasions, occasion#1, occasion#2, occasion#3, and occasion#4. Occasion#3 in the 4 PSFCH occasions belongs to resource pool#2, and the other three occasions belong to resource pool#1. Therefore, when the PUCCH feeds back HARQ-ACK bits of the 4 PSFCH occasions, HARQ-ACK bits corresponding to occasion#3 are all set to NACK information.

In some embodiments, in another example, the target sidelink channel resource is a resource within the sidelink channel resource range corresponding to the at least one target resource.

In some embodiments, in the method for determining SL feedback information according to this embodiment of the present disclosure, the target sidelink channel resource associated with the target uplink channel is grouped according to the target resource. For example, a resource associated with each target resource or a corresponding SL HARQ-ACK bit is concatenated sequentially according to an ID of the target resource.

Referring to FIG. 2, an embodiment of the present disclosure provides a communications device 200. The communications device 200 may be a network device or a terminal device, and may include:

a determining module 201, configured to determine a target uplink channel based on at least one target resource, where the target resource includes a resource pool, a subchannel, a BWP, or a carrier.

In some embodiments, in the communications device 200 according to this embodiment of the present disclosure, an association relationship between the target uplink channel and the at least one target resource includes at least one of the following: the target uplink channel is associated with one or more target resources of the at least one target resource; a resource set of the target uplink channel is associated with one or more target resources of the at least one target resource; a format of the target uplink channel is associated with one or more target resources of the at least one target resource; a sequence of the target uplink channel is associated with one or more target resources of the at least one target resource; a frequency domain resource of the target uplink channel is associated with one or more target resources of the at least one target resource; a time domain resource of the target uplink channel is associated with one or more target resources of the at least one target resource; or a frequency hopping pattern of the target uplink channel is associated with one or more target resources of the at least one target resource.

In some embodiments, in the communications device 200 according to this embodiment of the present disclosure, the target uplink channel is associated with a target sidelink channel resource. The target sidelink channel resource includes at least one of a PSFCH resource, a physical sidelink shared channel PSSCH resource, or a physical sidelink control channel PSCCH resource.

In some embodiments, in the communications device 200 according to this embodiment of the present disclosure, the target sidelink channel resource includes at least one resource beyond a sidelink channel resource range corresponding to the at least one target resource.

In some embodiments, in the communications device 200 according to this embodiment of the present disclosure, all SL HARQ feedback information corresponding to the at least one resource beyond the sidelink channel resource range corresponding to the at least one target resource is one of acknowledgment ACK information and negative acknowledgment NACK information.

In some embodiments, in the communications device 200 according to this embodiment of the present disclosure, the target sidelink channel resource is a resource within the sidelink channel resource range corresponding to the at least one target resource.

It can be understood that the communications device 200 provided according to this embodiment of the present disclosure can implement the foregoing method for determining an uplink resource performed by the communications device 200, and relevant descriptions about the method for determining an uplink resource all apply to the communications device 200, which are not described herein again.

In this embodiment of the present disclosure, the target uplink channel can be accurately determined based on the at least one target resource. That is, a required uplink resource can be accurately determined. Consequently, a user can report corresponding information smoothly to be consistent with information understood by the control node. The target resource may include a resource pool, a subchannel, a BWP, or a carrier.

FIG. 3 is a block diagram of a terminal device to which an embodiment of the present disclosure is applied. The terminal device 300 shown in FIG. 3 includes at least one processor 301, a memory 302, at least one network interface 304, and a user interface 303. All components in the terminal device 300 are coupled together through a bus system 305. It can be understood that the bus system 305 is configured to implement connection and communication between these components. In addition to a data bus, the bus system 305 further includes a power bus, a control bus, and a status signal bus. However, for clear description, various buses are marked as the bus system 305 in FIG. 3.

The user interface 303 may include a display, a keyboard, or a clicking device (for example, a mouse, a trackball), a touch panel, or a touchscreen.

It can be understood that the memory 302 in this embodiment of the present disclosure may be a volatile memory or a non-volatile memory, or may include both a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), and is used as an external cache. By way of example but not limitative description, many forms of RAMs may be used, for example, a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 302 in the system and the method that are described in the embodiments of the present disclosure is to include but is not limited to these memories and any other suitable types of memories.

In some implementation manners, the memory 302 stores the following elements: an executable module or a data structure, a subset thereof, or an extension set thereof: an operating system 3021 and an application program 3022.

The operating system 3021 includes various system programs, for example, a framework layer, a kernel library layer, and a driver layer, and is configured to implement various basic services and process a hardware-based task. The application program 3022 includes various application programs, for example, a media player and a browser, and is used to implement various application services. A program for implementing the method in the embodiments of the present disclosure may be included in the application program 3022.

In this embodiment of the present disclosure, the terminal device 300 further includes: a computer program that is stored in the memory 302 and that can be run on the processor 301. When the computer program is executed by the processor 301, the following steps are performed:

determining a target uplink channel based on at least one target resource, where the target resource includes a resource pool, a subchannel, a BWP, or a carrier.

The method disclosed in the foregoing embodiment of the present disclosure may be applied to the processor 301, or implemented by the processor 301. The processor 301 may be an integrated circuit chip having a signal processing capability. During implementation, each step of the foregoing method may be completed by using an integrated logic circuit of hardware in the processor 301 or an instruction in a form of software. The processor 301 may be a general-purpose processor, a Digital Signal Processor (DSP), an Application Specific Integrated Circuit (ASIC), a Field Programmable Gate Array (FPGA), or another programmable logic device, a discrete gate or transistor logic device, or a discrete hardware component. The processor may implement or perform the methods, the steps, and logical block diagrams that are disclosed in the embodiments of the present disclosure. The general-purpose processor may be a microprocessor, or the processor may be any conventional processor or the like. Steps of the methods disclosed with reference to the embodiments of the present disclosure may be directly executed and accomplished through a hardware decoding processor, or may be executed and accomplished by using a combination of a hardware module and a software module in the decoding processor. The software module may be located in a mature computer-readable storage medium in this field such as a random access memory, a flash memory, a read-only memory, a programmable read-only memory, an electrically erasable programmable memory, a register, or the like. The computer-readable storage medium is located in the memory 302, and the processor 301 reads information in the memory 302 and completes the steps in the foregoing method in combination with hardware of the processor. For example, the computer-readable storage medium stores a computer program, and when the computer program is executed by the processor 301, the steps of the method for determining an uplink resource in the foregoing embodiment are implemented.

It can be understood that the embodiments described in the present disclosure may be implemented by hardware, software, firmware, middleware, microcode, or a combination thereof. For implementation with hardware, the processing unit may be implemented in one or more ASICs, a DSP, a DSP Device (DSPD), a Programmable Logic Device (PLD), an FPGA, a general-purpose processor, a controller, a microcontroller, a microprocessor, another electronic unit for implementing the functions of the present disclosure, or a combination thereof.

For implementation with software, technologies described in the embodiments of the present disclosure may be implemented by using a module (for example, a process or a function) that performs the function in the embodiments of the present disclosure. A software code may be stored in the memory and executed by the processor. The memory may be implemented in the processor or outside the processor.

In this embodiment of the present disclosure, the target uplink channel can be accurately determined based on the at least one target resource. That is, a required uplink resource can be accurately determined. Consequently, a user can report corresponding information smoothly to be consistent with information understood by the control node. The target resource may include a resource pool, a subchannel, a BWP, or a carrier.

The terminal device 300 can implement each process implemented by the communications device in the foregoing embodiments. To avoid repetition, details are not described herein again.

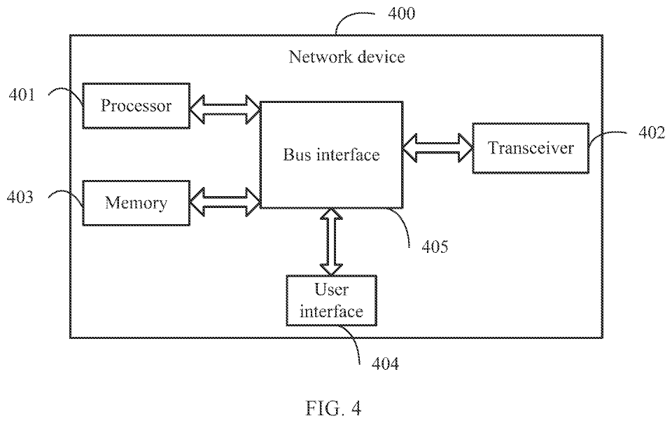

Referring to FIG. 4, FIG. 4 is a structural diagram of a network device to which an embodiment of the present disclosure is applied, so that details of the foregoing beam information update method can be implemented, and the same effect can be achieved. As shown in FIG. 4, a network device 400 includes a processor 401, a transceiver 402, a memory 403, a user interface 404, and a bus interface 405.

In this embodiment of the present disclosure, the network device 400 further includes: a computer program that is stored in the memory 403 and that can be run on the processor 401. When the computer program is executed by the processor 401, the following steps are performed:

determining a target uplink channel based on at least one target resource, where the target resource includes a resource pool, a subchannel, a BWP, or a carrier.

In FIG. 4, a bus architecture may include any quantity of interconnected buses and bridges, which are connected together by various circuits of one or more processors represented by the processor 401 and a memory represented by the memory 403. The bus architecture may further link various other circuits such as a peripheral device, a voltage regulator, and a power management circuit together. These are all well-known in the art, and therefore are not further described in this specification. The bus interface 405 provides an interface. The transceiver 402 may be multiple elements, in other words, includes a transmitter and a receiver, and provides a unit configured to communicate with various other apparatuses on a transmission medium. For different user equipment, the user interface 404 may be further an interface capable of connecting externally and internally a required device. The connected device includes but is not limited to a keypad, a display, a speaker, a microphone, a joystick, and the like.

The processor 401 is responsible for managing the bus architecture and common processing, and the memory 403 may store data used when the processor 401 performs an operation.

In this embodiment of the present disclosure, the target uplink channel can be accurately determined based on the at least one target resource. That is, a required uplink resource can be accurately determined. Consequently, a user can report corresponding information smoothly to be consistent with information understood by the control node. The target resource may include a resource pool, a subchannel, a BWP, or a carrier.

For example, an embodiment of the present disclosure further provides a communications device (a network device or a terminal device), including a processor, a memory, and a computer program that is stored in the memory and that can be run on the processor. When the computer program is executed by the processor, each process of the method for determining an uplink resource in the foregoing embodiment is implemented, and a same technical effect can be achieved. To avoid repetition, details are not described herein again.

An embodiment of the present disclosure further provides a computer-readable storage medium, where the computer-readable storage medium stores a computer program, and when the computer program is executed by a processor, each process of the foregoing method for determining an uplink resource, applied to the communications device (the network device or the terminal device), are implemented, and a same technical effect can be achieved. To avoid repetition, details are not described herein again. The computer readable storage medium is, for example, a ROM, a RAM, a magnetic disk, an optical disc, or the like.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. Without more restrictions, an element defined by the statement “including a” does not exclude another same element in this process, method, article, or apparatus that includes the element.

Based on the descriptions of the foregoing implementation manners, a person skilled in the art may clearly understand that the method in the foregoing embodiment may be implemented by software in addition to a necessary universal hardware platform or by hardware only. In most circumstances, the former is an exemplary implementation manner. Based on such understanding, the technical solutions of the present disclosure essentially or the part contributing to existing technologies may be implemented in a form of a software product. The computer software product is stored in a storage medium (such as a ROM/RAM, a magnetic disk, or an optical disc) and includes several instructions for instructing a terminal (which may be a mobile phone, a computer, a server, an air conditioner, or a network device) to perform the methods described in the embodiments of the present disclosure.

The embodiments of the present disclosure are described with reference to the accompanying drawings. However, the present disclosure is not limited to the foregoing implementation manners. The foregoing implementation manners are merely examples, but are not limiting. Under the enlightenment of the present disclosure, a person of ordinary skill in the art may make many forms without departing from the objective and the scope of the claims of the present disclosure, and these forms all fall within the protection scope of the present disclosure.

1. A method for determining an uplink resource, performed by a communications device, the method comprising:
determining a target uplink channel based on at least one target resource, wherein the target resource comprises a resource pool, a subchannel, a Bandwidth Part (BWP), or a carrier.

2. The method according to claim 1, wherein an association relationship between the target uplink channel and the at least one target resource comprises at least one of the following:
the target uplink channel is associated with one or more target resources of the at least one target resource;
a resource set of the target uplink channel is associated with one or more target resources of the at least one target resource;
a format of the target uplink channel is associated with one or more target resources of the at least one target resource;
a sequence of the target uplink channel is associated with one or more target resources of the at least one target resource;
a frequency domain resource of the target uplink channel is associated with one or more target resources of the at least one target resource;
a time domain resource of the target uplink channel is associated with one or more target resources of the at least one target resource; or
a frequency hopping pattern of the target uplink channel is associated with one or more target resources of the at least one target resource.

3. The method according to claim 1, wherein the target uplink channel is associated with a target sidelink channel resource, wherein the target sidelink channel resource comprises at least one of a Physical Sidelink Feedback Channel (PSFCH) resource, a Physical Sidelink Shared Channel (PSSCH) resource, or a Physical Sidelink Control Channel (PSCCH) resource.

4. The method according to claim 3, wherein the target sidelink channel resource comprises at least one resource beyond a sidelink channel resource range corresponding to the at least one target resource.

5. The method according to claim 4, wherein all Sidelink Hybrid Automatic Repeat Request (SL HARQ) feedback information corresponding to the at least one resource beyond the sidelink channel resource range corresponding to the at least one target resource is one of Acknowledgment (ACK) information and Negative Acknowledgment (NACK) information.

6. The method according to claim 3, wherein the target sidelink channel resource is a resource within a sidelink channel resource range corresponding to the at least one target resource.

7. A communications device, comprising: a memory, a processor, and a computer program that is stored in the memory and that can be run on the processor, wherein the computer program, when executed by the processor, causes the processor to perform a method for determining an uplink resource, the method comprising:
determining a target uplink channel based on at least one target resource, wherein the target resource comprises a resource pool, a subchannel, a Bandwidth Part (BWP), or a carrier.

8. The communications device according to claim 7, wherein an association relationship between the target uplink channel and the at least one target resource comprises at least one of the following:
the target uplink channel is associated with one or more target resources of the at least one target resource;
a resource set of the target uplink channel is associated with one or more target resources of the at least one target resource;
a format of the target uplink channel is associated with one or more target resources of the at least one target resource;
a sequence of the target uplink channel is associated with one or more target resources of the at least one target resource;
a frequency domain resource of the target uplink channel is associated with one or more target resources of the at least one target resource;
a time domain resource of the target uplink channel is associated with one or more target resources of the at least one target resource; or
a frequency hopping pattern of the target uplink channel is associated with one or more target resources of the at least one target resource.

9. The communications device according to claim 7, wherein the target uplink channel is associated with a target sidelink channel resource, wherein the target sidelink channel resource comprises at least one of a Physical Sidelink Feedback Channel (PSFCH) resource, a Physical Sidelink Shared Channel (PSSCH) resource, or a Physical Sidelink Control Channel (PSCCH) resource.

10. The communications device according to claim 9, wherein the target sidelink channel resource comprises at least one resource beyond a sidelink channel resource range corresponding to the at least one target resource.

11. The communications device according to claim 10, wherein all Sidelink Hybrid Automatic Repeat Request (SL HARQ) feedback information corresponding to the at least one resource beyond the sidelink channel resource range corresponding to the at least one target resource is one of Acknowledgment (ACK) information and Negative Acknowledgment (NACK) information.

12. The communications device according to claim 9, wherein the target sidelink channel resource is a resource within a sidelink channel resource range corresponding to the at least one target resource.

13. A non-transitory computer-readable storage medium, wherein the non-transitory computer-readable storage medium stores a computer program, when the computer program executed by a processor, causes the processor to perform a method for determining an uplink resource, the method comprising:
determining a target uplink channel based on at least one target resource, wherein the target resource comprises a resource pool, a subchannel, a Bandwidth Part (BWP), or a carrier.

14. The non-transitory computer-readable storage medium according to claim 13, wherein an association relationship between the target uplink channel and the at least one target resource comprises at least one of the following:
the target uplink channel is associated with one or more target resources of the at least one target resource;
a resource set of the target uplink channel is associated with one or more target resources of the at least one target resource;
a format of the target uplink channel is associated with one or more target resources of the at least one target resource;
a sequence of the target uplink channel is associated with one or more target resources of the at least one target resource;
a frequency domain resource of the target uplink channel is associated with one or more target resources of the at least one target resource;
a time domain resource of the target uplink channel is associated with one or more target resources of the at least one target resource; or
a frequency hopping pattern of the target uplink channel is associated with one or more target resources of the at least one target resource.

15. The non-transitory computer-readable storage medium according to claim 13, wherein the target uplink channel is associated with a target sidelink channel resource, wherein the target sidelink channel resource comprises at least one of a Physical Sidelink Feedback Channel (PSFCH) resource, a Physical Sidelink Shared Channel (PSSCH) resource, or a Physical Sidelink Control Channel (PSCCH) resource.

16. The non-transitory computer-readable storage medium according to claim 15, wherein the target sidelink channel resource comprises at least one resource beyond a sidelink channel resource range corresponding to the at least one target resource.

17. The non-transitory computer-readable storage medium according to claim 16, wherein all Sidelink Hybrid Automatic Repeat Request (SL HARQ) feedback information corresponding to the at least one resource beyond the sidelink channel resource range corresponding to the at least one target resource is one of Acknowledgment (ACK) information and Negative Acknowledgment (NACK) information.

18. The non-transitory computer-readable storage medium according to claim 15, wherein the target sidelink channel resource is a resource within a sidelink channel resource range corresponding to the at least one target resource.
